(19) United States
(12) Patent Application Publication
(10) Pub. No.: US 2010/0306265 A1
(43) Pub. Date: Dec. 2, 2010

(54) DATA AND EVENT MANAGEMENT SYSTEM AND METHOD

(75) Inventor: James L. Jones, III, Chantilly, VA (US)

Correspondence Address: GIFFORD, KRASS, SPRINKLE,ANDERSON & CITKOWSKI, P.C, PO BOX 7021, TROY, MI, 48007-7021, US

(73) Assignee: Dynology Corporation

(21) Appl. No.: 12/793,996

(22) Filed: Jun. 4, 2010

Related U.S. Application Data
(63) Continuation of application No. 12/467,552, filed on May 18, 2009, now abandoned.

(51) Int. Cl. G06F 17/30

(52) U.S. Cl. 707/776; 707/802; 707/E17.005; 707/E17.014; 707/769

(57) ABSTRACT

A management system and method for facilitating the management of data and events. The system includes a server, a processor, and a feed in communication with the server. The feed provides real-time information relating to a predetermined group of people and/or facilities. The processor is operable to process the information delivered by the feed and update a first database. The system also includes a computer processing unit (CPU), an interface and a document associating circuit. The CPU processes the server and the second database so as to provide information onto a display. The document associating circuit is operable to process the first and second databases so as to associate documents stored in the first and second databases with each event displayed on the calendar and deliver the associated document with a selected event.

### CROSS-REFERENCE TO RELATED APPLICATION

This application is a continuation of U.S. patent application Ser. No. 12/467,552 filed May 18, 2009.

### FIELD OF THE INVENTION

The present invention relates generally to a management system and method for facilitating the management of data and events and for facilitating the preparation of an event or meeting.

### DESCRIPTION OF MATERIAL ART

There are many systems currently known and used which facilitate the management of data and events. Such systems typically include a calendar feature which allows a user to input dates and events, and an alert which reminds the user of the pending dates and events. Current management systems also include filter and search features which allow the user to search through a database to locate data, such as electronic documents and files. Such data may be stored in the database or may be gathered from the World Wide Web. However, such systems still require the user to locate documents associated with an event and locating such documents may be time consuming. Accordingly it remains desirable to have a management system for managing data and events which will deliver documents and data for specific events or action items or personnel.

Current systems also include an address book containing a list of addresses. The address book provides contact information as well as personal information relating to each contact. However, electronic files relating to the contact must be searched for. Thus, when placing a call to a particular contact, the user must search the database for electronic files which may be necessary to reference during the call. Furthermore, current systems require the user to manually update contact information. This may be a time consuming task and may also be overlooked during the course of a busy day.

Accordingly, it remains desirable to have a management system for managing data and events which will provide electronic documents and data for specific events and personnel so as to assist in the preparation or execution of a meeting. It also remains desirable to have a management system that keeps the address book updated.

### SUMMARY OF THE PRESENT INVENTION

The present invention provides a management system and method for assisting with the management of data and events. The management system includes a server having a first database and a processor. The system also includes a feed in communication with the server. The feed provides real-time information relating to a predetermined group of people and/or facilities. The processor is operable to process the real-time information delivered by the feed and update the first database with the information from the feed at a predetermined interval.

The system also includes a computer processing unit (CPU) having an interface and a display. The CPU is in communication with a second database. The CPU is also in communication with the server and processes the server and the second database so as to provide information onto a display such as a monitor.

The management system further includes a calendar and a document associating circuit. The interface is operable to input events onto the calendar and the calendar is operable to associate an event with a predetermined time. The document associating circuit is operable to process the first and second databases so as to associate documents stored in the first and second databases with each event displayed on the calendar. The interface is further operable to select any of the events on the calendar so as to deliver the associated document with the selected event.

The management system further includes an address book. The address book contains a list of contacts and information relating to each of the contacts. The address book may be stored in the second database and the server is operable to process and upload the feed into the address book so as to update the addresses and information of each of the contacts. The interface is further operable to manually add contacts and information to the list of contacts, or edit the contacts.

The management system also includes a biography database. The biography database contains a list of biographies. Each biography in the list includes information relating to personnel. The server is operable to update the list of biographies with information provided by the feed and the interface is further operable to add biographies to the list of biographies.

The system also includes a reporting database containing at least one report. The report may be created manually. For instance, the interface may be operable to create a report and the CPU processes the created report and stores the created report in the reporting database. Additionally, a report may be uploaded into the reporting database. The server may also be operable to update information on the report using information provided by the feed, such as telephone numbers, addresses, or job title changes.

The management system may also include an alert. The alert is operable to provide reminders relating to time sensitive events. For instance an alert may be generated for a report that is due or for a calendar event.

Accordingly the management system automatically associates documents with corresponding events, dates and times that are displayed on the calendar so as to allow the user to readily review any documents which may be pertinent to an upcoming event or meeting.

### BRIEF DESCRIPTION OF THE DRAWINGS

FIG. 1 is a diagram illustrating the components of the management system of the present invention;

FIG. 2 is an illustration of a calendar;

FIG. 2a is an illustration of the calendar of FIG. 2 showing the operation of the filter and status circuit;

FIG. 3 is an illustration of an address book;

FIGS. 3a-3e is an illustration of the operation of the document associating circuit and event associating circuits wherein all documents, events, activities, issues and remarks related to the selected contact have been delivered onto the display;

FIG. 4 is an illustration of a display of the reporting database;

FIG. 5-5a is an illustration of the operation of the document and event associating circuit delivering all documents and events associated with a selected report;

FIG. 6 is an illustration of a display of the facilities database;

FIG. 6a is an illustration of the operation of the zip code associating circuit wherein a list of all personnel stored in the first and second database are delivered;

FIG. 7 is an illustration of a preferred embodiment of the management system;

FIG. 7a is an illustration of the home page of the management system of FIG. 7; and

FIG. 8 is a diagram showing the steps of a method for managing data.

### DETAILED DESCRIPTION OF A PREFERRED EMBODIMENT OF THE PRESENT INVENTION

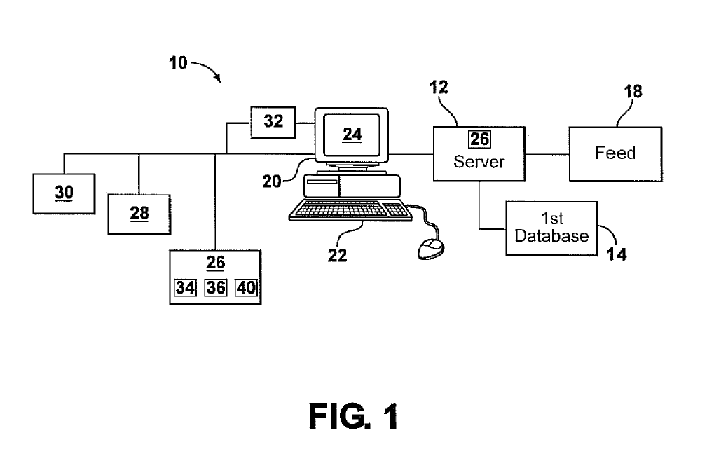

With reference first to FIG. 1, a preferred embodiment of a management system 10 is provided. The management system 10 facilitates the management of data and events by delivering documents associated with a particular event. Thus, the management system 10 facilitates the preparation of an event such as a meeting by delivering all electronic files relating to the event.

The management system 10 includes a server 12 having a first database 14 and a processor 16. The server 12 may be in communication with a feed 18. The feed 18 provides real-time information relating to a predetermined group of people and facilities. Any feed 18 currently known and used in the art is adaptable for use herein illustratively including a feed 18 which provides updated information relating to congressional personnel and their staff and government facilities. The processor 16 is operable to process the real-time information delivered by the feed 18 and update the first database 14 with the real-time information so as to keep the first database 14 current. The updates may take place at a predetermined interval wherein the updates may occur once, twice or three times a day.

The management system 10 further includes a computer processing unit (CPU) 22 and an interface 20 in communication with the CPU 22. The CPU 22 includes a second database 24 for storing information. More specifically, the interface 20 is operable to create documents which the CPU 22 may store in the second database 24. Furthermore, the CPU 22 may be operable to receive documents and store those documents in the second database 24. The CPU 22 is in communication with the server 12. It is anticipated that the server 12 may be housed remotely from the CPU 22 and may be in communication with the CPU 22 wirelessly or through other networking systems currently known and used in the art, illustratively including a local area network.

The management system 10 may further include a calendar 26, an address book 28, a reporting database 30 and a document associating circuit 32. The interface 20 is operable to input events into the calendar 26, and contacts into the address book 28. Additionally, the interface 20 may be operable to manipulate the events and contacts so as to manually update and edit the calendar 26 and address book 28.

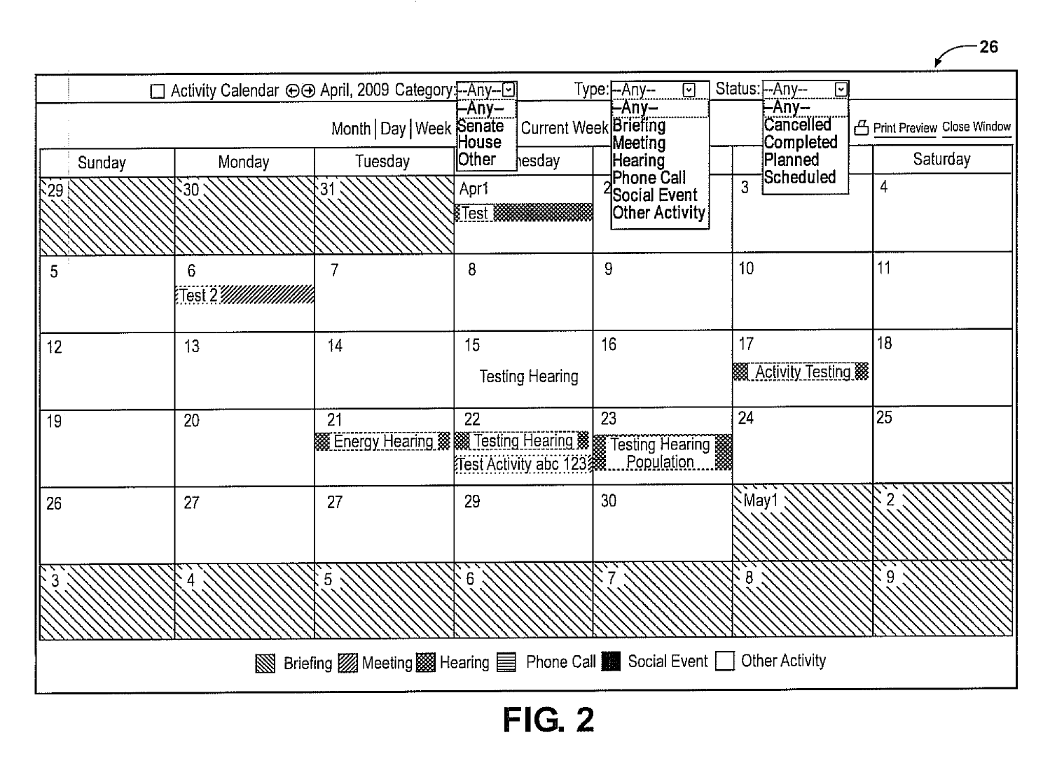

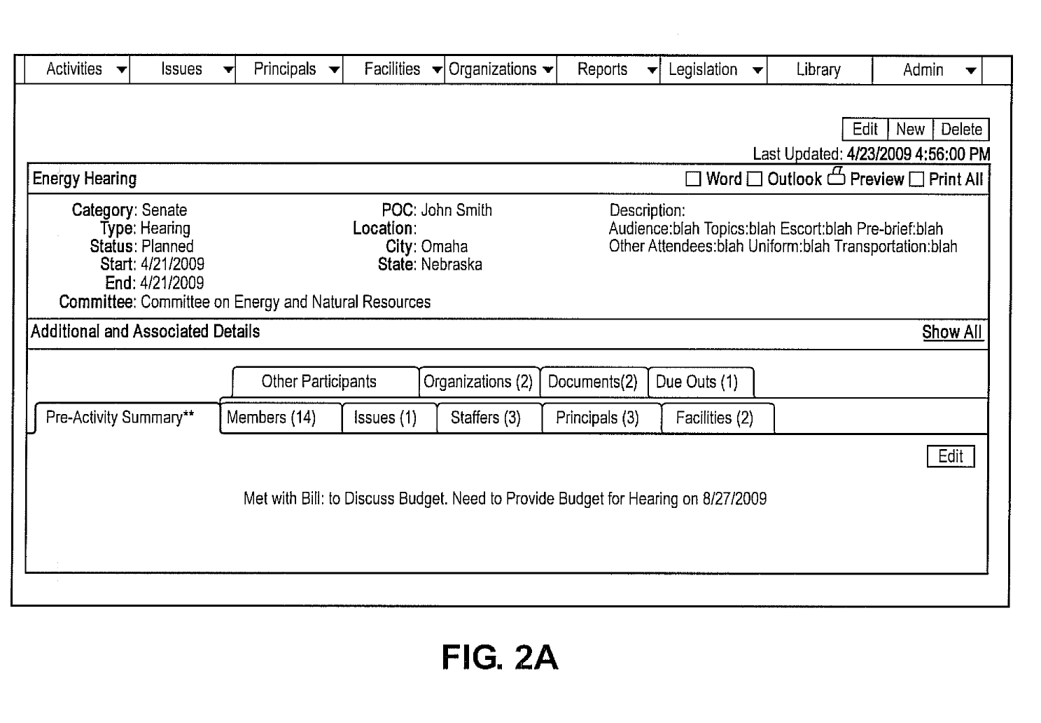

With reference now to FIG. 2, an illustration of a calendar 26 is provided. The calendar 26 is operable to associate an event with a predetermined time and the document associating circuit 32 is operable to process the first and second databases 14, 24 so as to associate documents stored in the first and second databases 14, 24 with each event displayed on the calendar 26. The interface 20 is operable to select any of the events displayed on the calendar 26 wherein the associated documents are delivered with the selected event. Accordingly the management system 10 facilitates the preparation of a meeting by delivering all documents associated with the meeting to the user.

The calendar 26 further includes a status circuit 34. The status circuit 34 is operable to label each calendar event with a status. For instance, one status may indicate whether the event has been completed, another status may indicate that the event has been cancelled. Other status labels may include whether the event has been planned, or the planning is incomplete. Additionally, the events may be further coded so as to provide an easily recognizable indication of which of the status of the event. For illustrative purposes, each level is coded with a different shade, however it is anticipated that the levels may be coded in color. For instance, a “Cancelled” event may be highlighted in yellow, a “completed” event may be highlighted in green, while an “incomplete” event may be highlighted in red. The code is particularly useful when two or more events are scheduled for the same day as the code provides the user with notice of which of the day's events has priority.

The calendar 26 may further include a filtering circuit 36. The filtering circuit 36 is operable to associate each event with a particular label 38 from different group of labels 40. For instance, one group of labels 40 may categorize the events by whether or not the event is associated with a “Senate,” “House,” or “Other” function. Another of the group of labels 40 may include labels 38 associating a calendar event with a particular type of events. For instance, the types of events may include “Briefing,” “Meeting,” “Hearing,” “Phone Call,” “Social Event,” and “Other Activity,” and the like.

In operation, the filtering circuit 36 is actuated by an interface 20 such as a mouse. The calendar 26 provides a drop down menu 42 for each of the group of labels 40, and the different status of each event. Specifically, a drop down menu 42 is provided for the group of labels 40 identified as “category,” “type,” and “status.” The interface 20 is operable to select any one of the group of labels 40 so as to prompt the respective drop down menu 42 to appear. The user simply selects which one of the labels 38 from each of the group of labels 40 the user wants the calendar 26 to display. Upon selection of the label 38, the filtering circuit 36 identifies which of the calendar events is associated with the selected labels 38 and displays only those events having the selected label 38. Thus, the filtering circuit 36 is helps focus the user onto events that are desired, and eliminates events which are not desired so as to clear up the calendar.

The interface is further operable to select any one of the events displayed on the calendar. Upon selection, the system is operable to deliver all documents and contacts relating to the event so as to help prepare the user for the upcoming meeting as shown in FIG. 2a. In stances where the event has passed, the system memorializes the event by providing all the documents and contacts relating to the event as well as any manually entered notes summarizing the event.

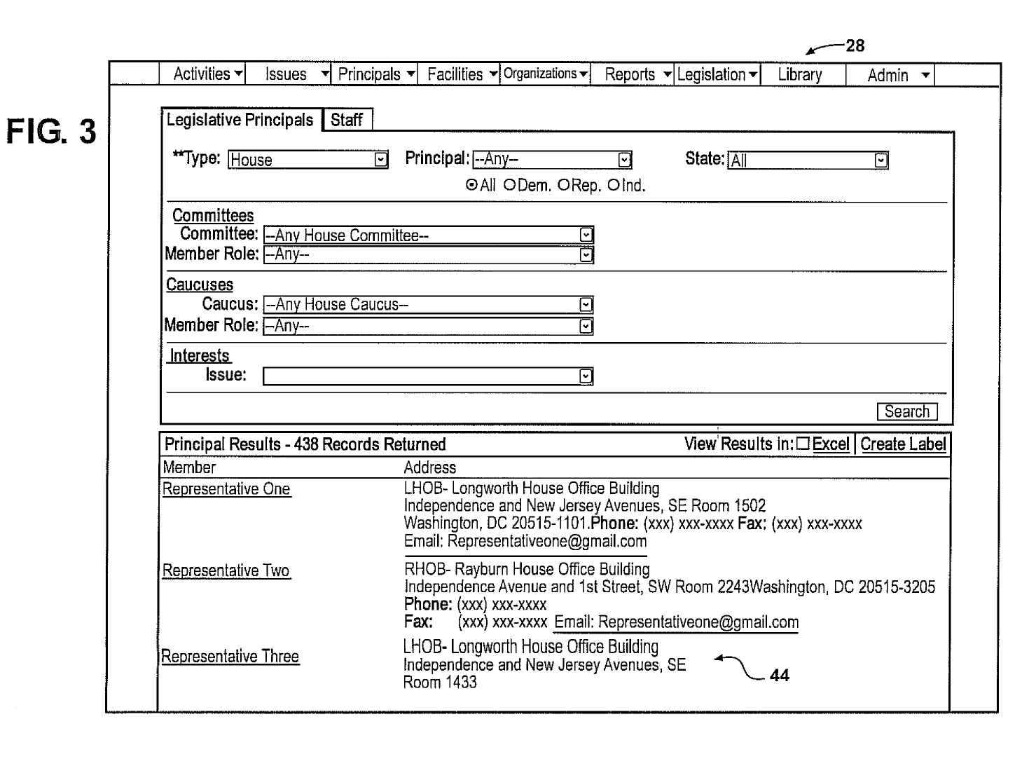

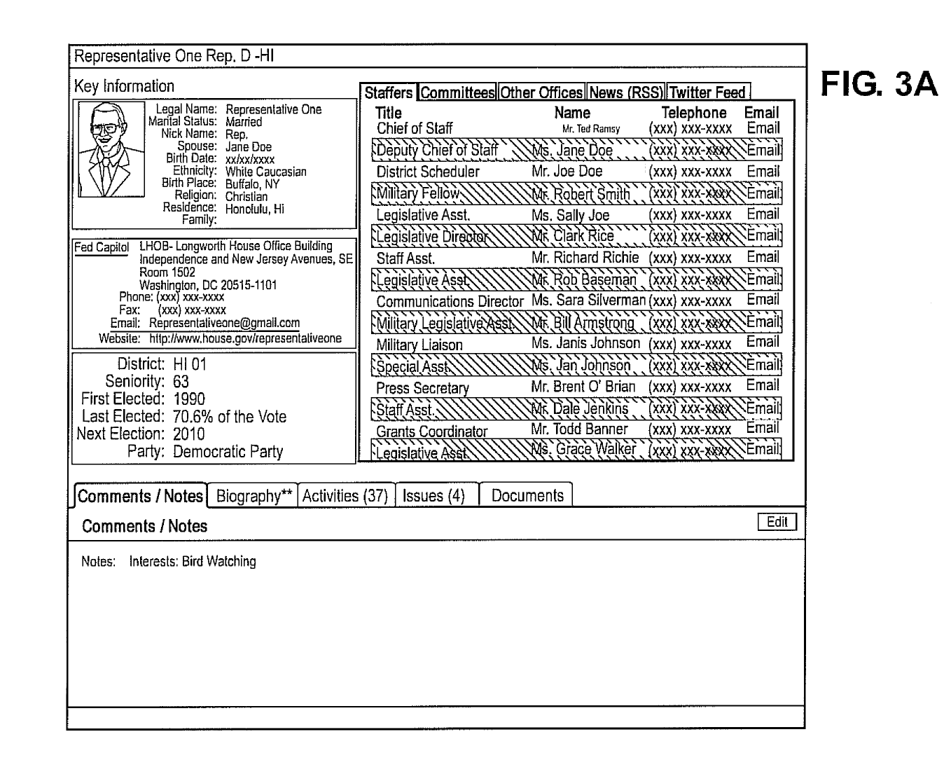

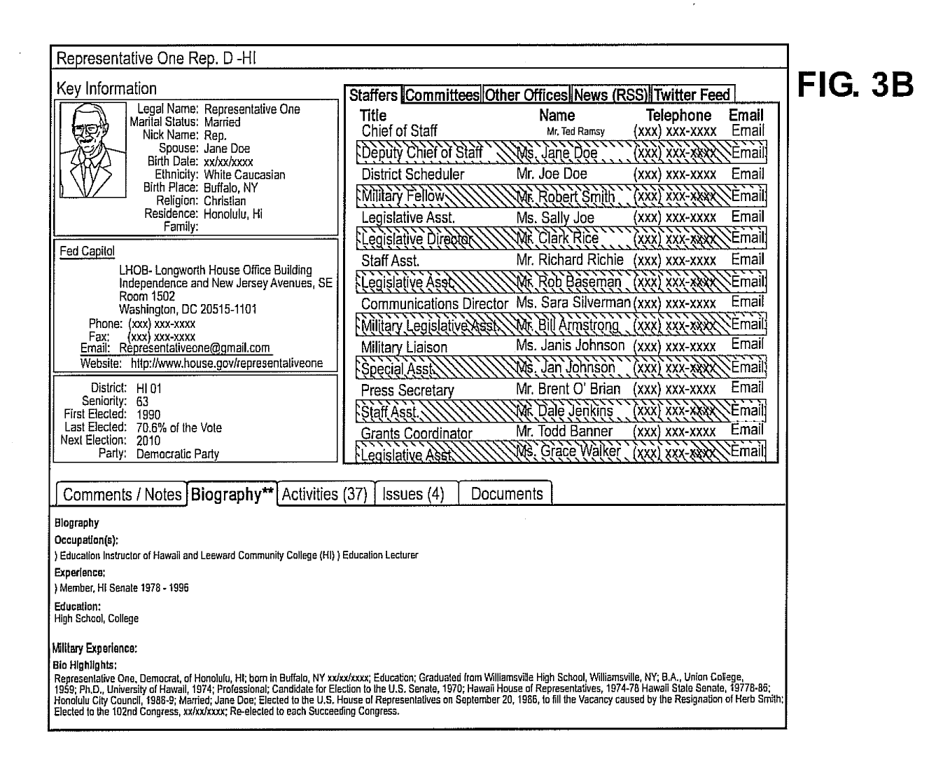

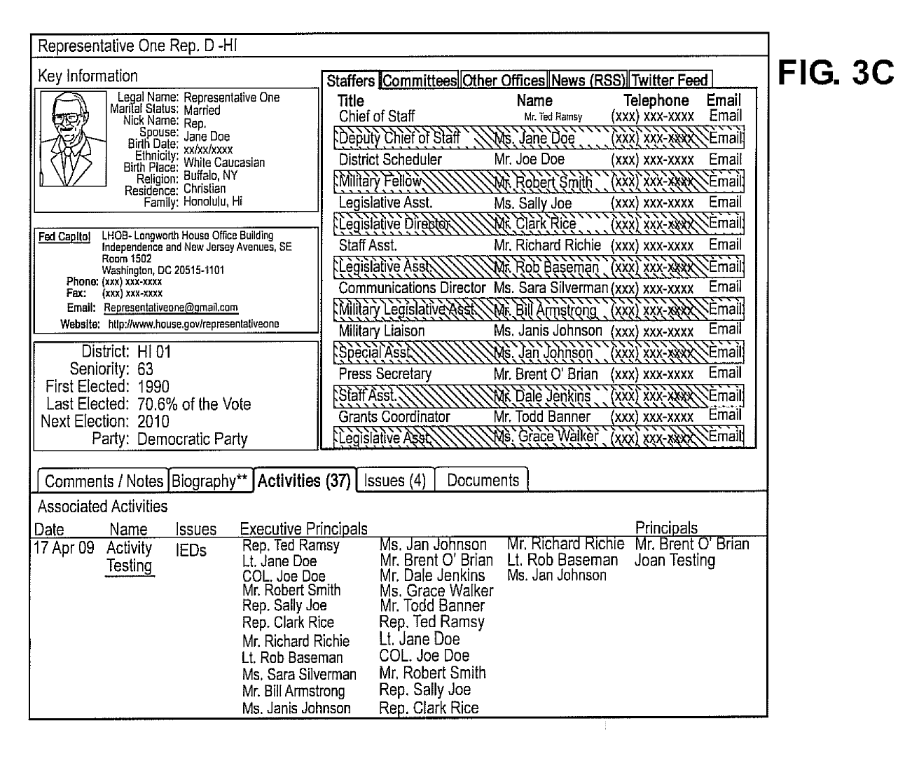

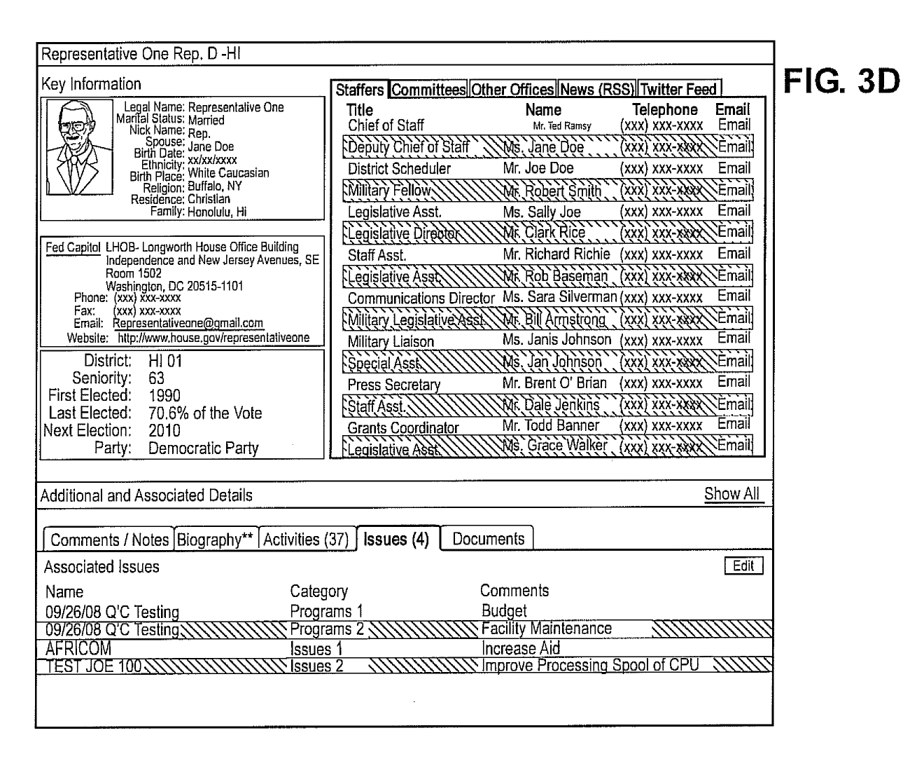

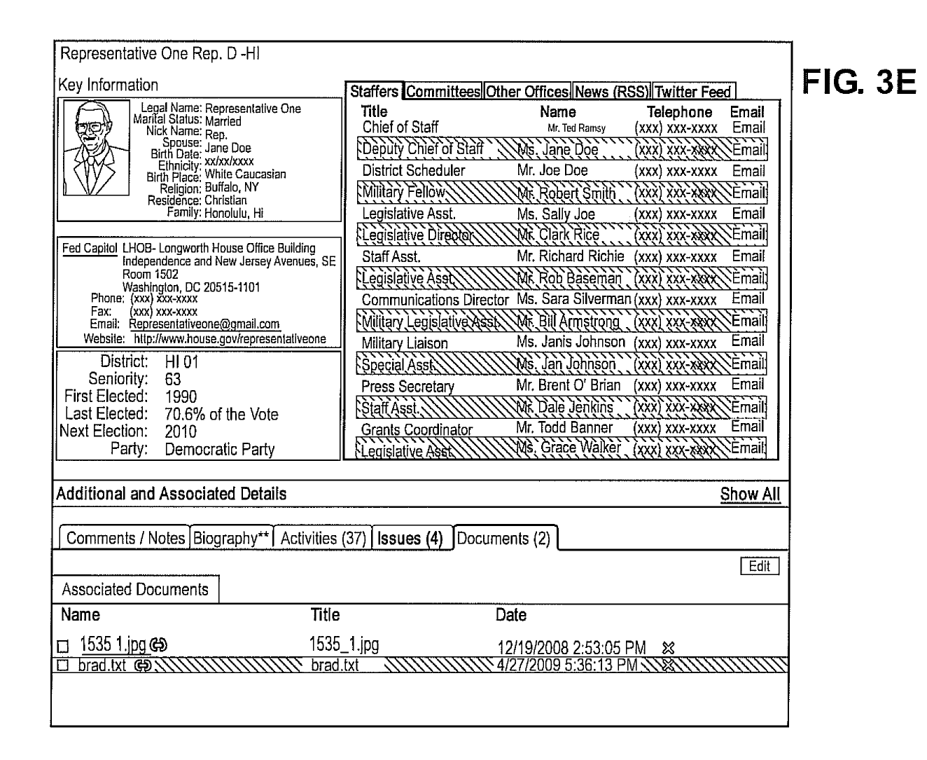

With reference now to FIG. 3, an illustration of an address book 28 is provided. The address book 28 has a list of contacts 44 and information relating to each of the contacts in the list 44. The address book 28 is stored in the second database 24 and the server 12 is operable to upload the feed 18 and process feed information so as to update each of the contacts in the address book 28 and keep the address book 28 current. The address book further includes an address filter circuit. The address filter circuit is operable to filter the address book so as to deliver a selected group of contacts.

With reference now to FIG. 3e another illustration of the operation of the document associating circuit 32 is provided. The document associating circuit 32 may also be in communication with the address book 28. The document associating circuit 32 is operable to process the address book 28, and the first and second databases 14, 24 and associate all of the documents stored in either the first or second database 14, 24 to each of the contacts in the address book 28. Upon selection of a contact from the address book 28 the document associating circuit 32 is actuated so as to deliver all of the documents stored in the first and second databases 14, 24 relating to the selected contact.

The system may further include an event associating circuit 46. With reference now to FIG. 3c, the operation of the event associating circuit is provided. The event associating circuit 46 is operable to associate an event with any of the contacts in the address book 28. Specifically, the event associating circuit 46 processes the calendar 26 so as to determine if any of the events are associated with any one of the contacts. Accordingly, upon selection of a contact, the event associating circuit 46 may deliver all of the events pertaining to the selected contact. It is anticipated that the system may be configured to actuate the document associating circuit 32 and event associating circuit 46 automatically upon selection of a contact. Alternatively, the document associating circuit 32 and the event associating circuit 46 may be actuated independently by the interface 20.

With reference now to FIG. 3b, an illustration of the biography database 48 is provided. The biography database 48 contains a list of biographies 50. Each of the biographies in the list includes biographical information relating to a particular person. The server 12 is operable to update the list of biographies 50 with information provided by the feed 18. The interface 20 is operable to add biographies to the list of biographies 50 and manually update the list of biographies 50. Additionally, the server 12 may process information from the feed 18 and update the biography database 48 with the processed feed information so as to maintain the biographies current.

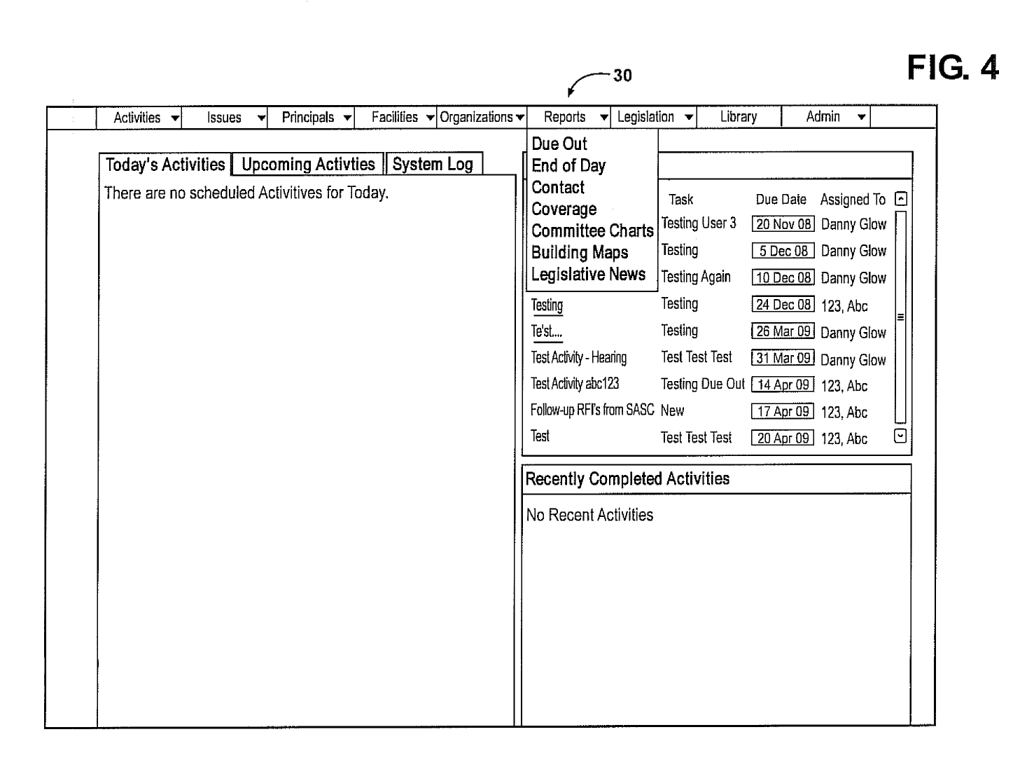

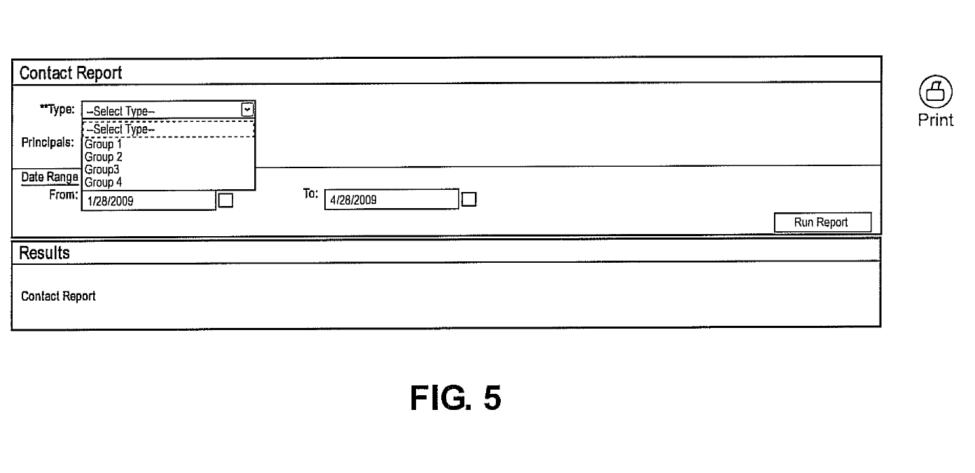

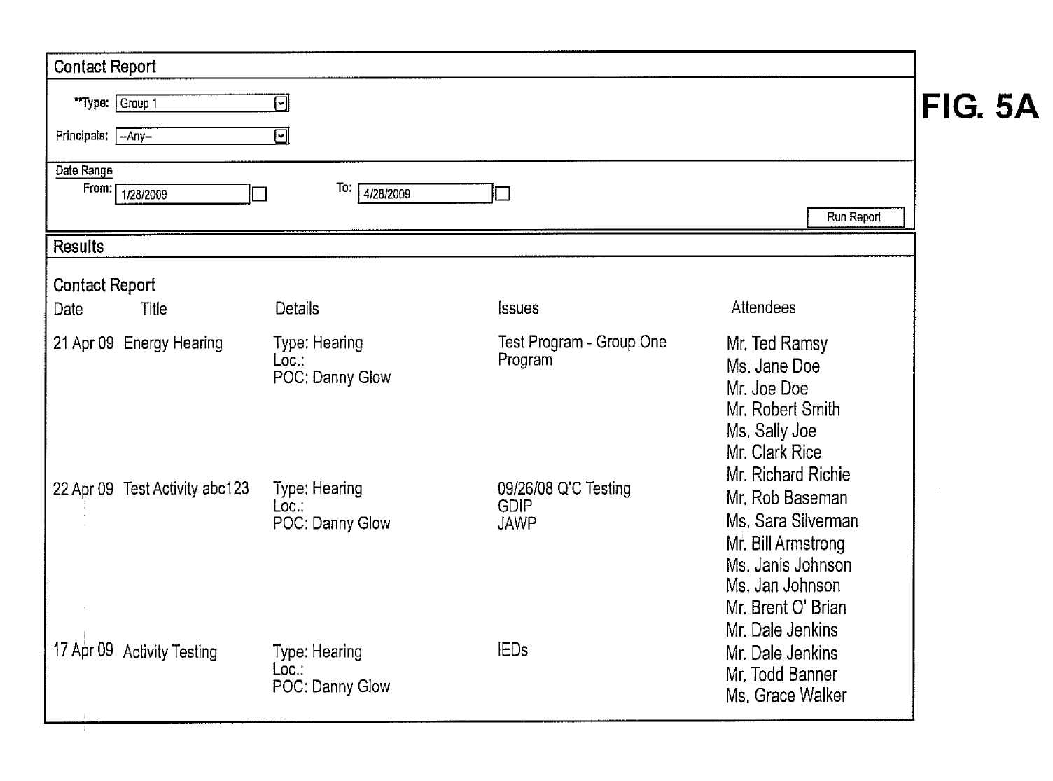

With reference now to FIGS. 4 and 5, an illustration of the reporting database 30 is provided. The reporting database 30 may contain reports generated by a user or manufactured reports uploaded into the CPU 22. The server 12 is operable to store the reports in the reporting database 30. The server 12 is further operable to update information on the report using information provided by the feed 18.

With reference now to FIGS. 5a and 2a, another illustration of the document associating circuit 32 and the event associating circuit 46 is provided. As shown, the reports contained in the reporting database 30 may be displayed by due date in a sequential manner. The document associating circuit 32 may also be in communication with the reporting database 30. The document associating circuit 32 is operable to process the reporting database 30 and the address book 28 as well as the first and second databases 14, 24. Upon selection of a report by the interface 20 the document associating circuit 32 is operable to deliver all of the documents stored in the first and second databases 14, 24 as well as all the contacts that are related to the selected report. Likewise, the event associating circuit 46 is operable to process the reporting database 30 and the first and second database 14, 24 so as to associate a particular event with a particular report. Accordingly when generating a report the management system 10 provides the user with all the documents associated with the report, the contacts in the address book 28 that are related to the report, and all of the events that are related to the report.

The management system 10 may further include an alert 52. The alert 52 may be actuated when a report or an event is due. It is inherent that the alert 52 may be scheduled to provide predetermined periods of notice prior to the due date of a respective report or calendar 26 event.

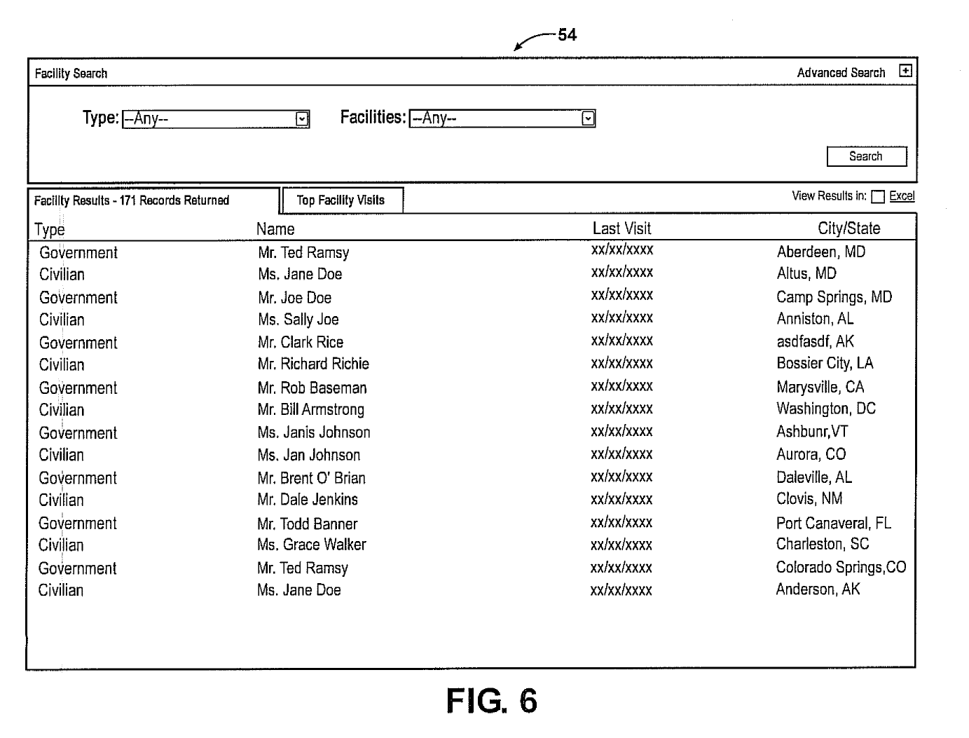

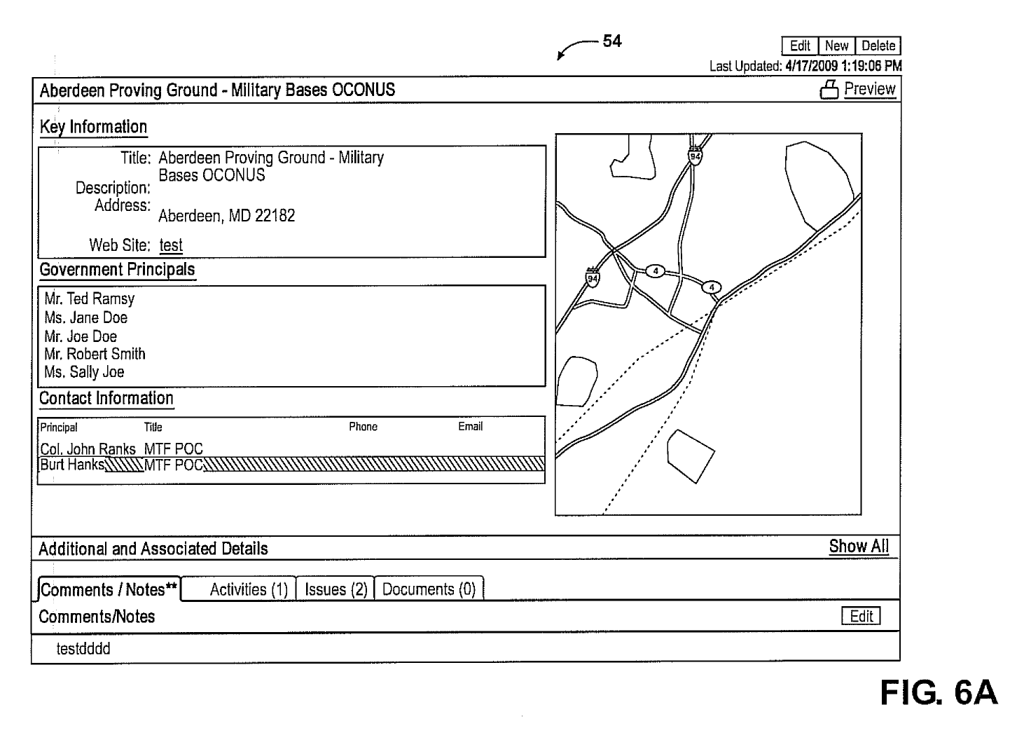

The system may further include a list of facilities 54 stored in the second database 24. With reference now to FIG. 6, an illustration displaying the facilities in the list of facilities 54 is provided. The list of facilities 54 may be arranged alphabetically, by geographic region, by function, or the like. The list of facilities 54 includes facilities and information relating to the facilities, the zip code, the street address, phone number, the type of facility, and the like. The server 12 is operable to process the feed 18 so as to update the list of facilities 54 and keep the list of facilities 54 current. The interface 20 may also be operable to manually update the list of facilities 54 and selectively choose a facility from the list of facilities 54.

The management system 10 may further include a zip code associating circuit 56. With reference now to FIG. 6a, an operation of the zip code associating circuit 56 is provided. The zip code associating circuit 56 is operable to identify people provided by the feed 18 that are associated with the zip code of any one of the facilities stored in the facilities database. The zip code associating circuit 56 may also search the address book 28 to identify contacts that have a zip code similar to the zip code of any one of the facilities stored in the facilities database.

The interface 20 is operable to selectively choose any one of the facilities located in the facilities database. Upon selection of a facility the zip code associating circuit 56 delivers a list of all contacts stored in the address book 28 and provided by the feed 18 that has a zip code that is the same as the zip code of the selected facility. It is anticipated that the zip code associating circuit 56 may be scaled. For example, the zip code associating circuit 56 may be configured to deliver a list of all personnel having a zip code that is within a predetermined geographical area of the zip code of the facility selected from the facilities database.

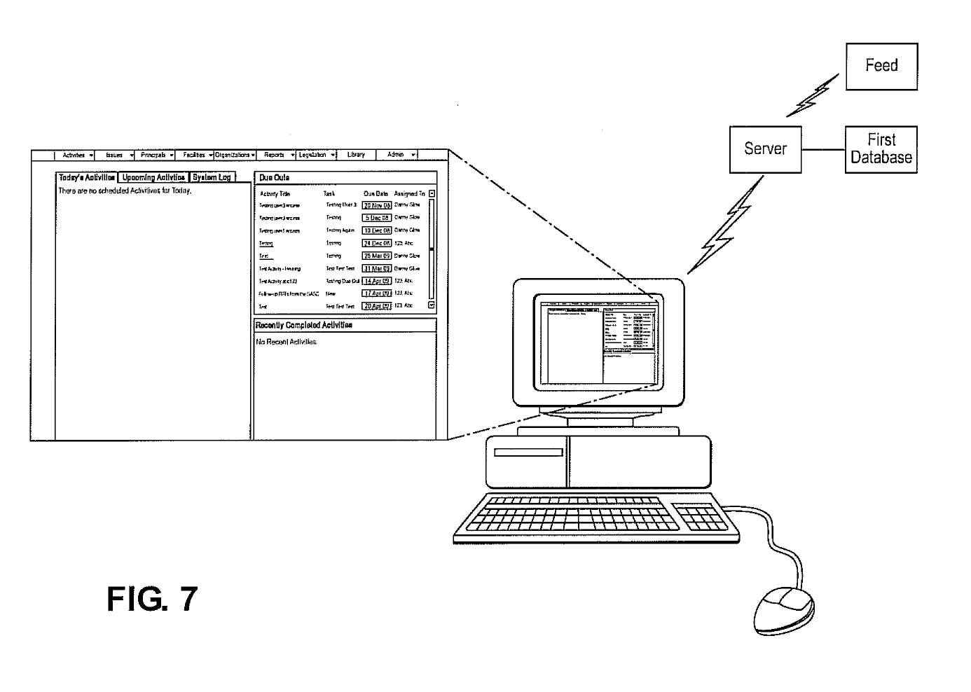

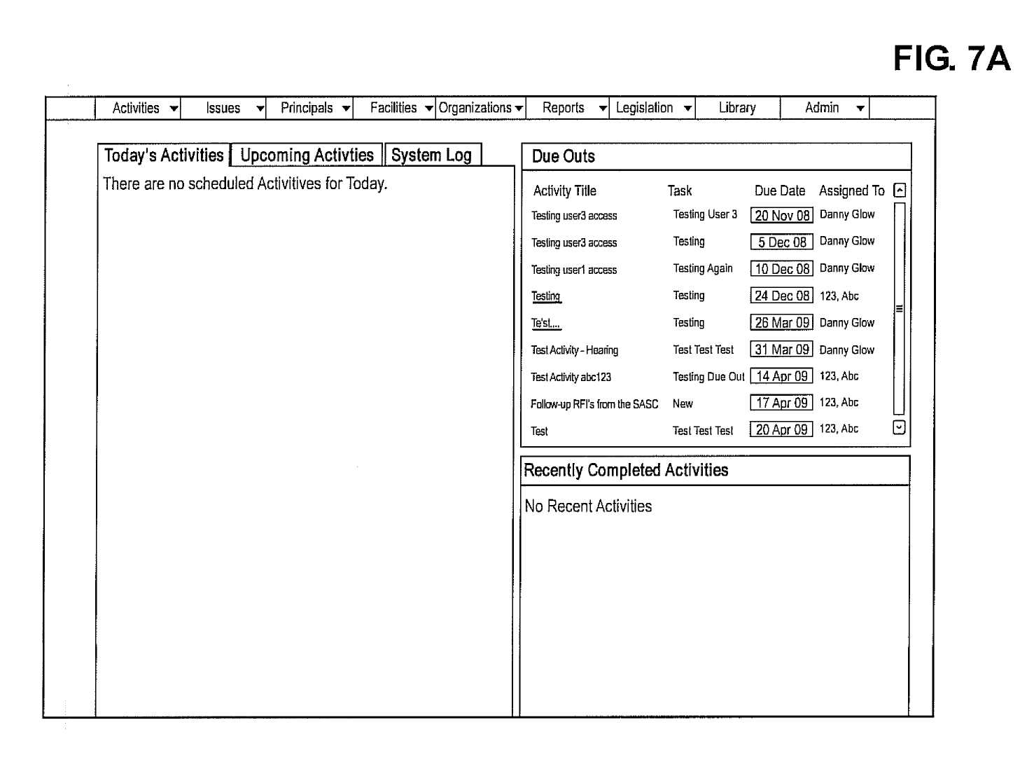

With reference now to FIG. 7, a preferred embodiment of the system is provided. In the preferred embodiment, the management system 10 is a web-based system wherein the CPU 22 is housed remotely from a server 12. The server 12 is in communication with the CPU 22 wirelessly or alternatively may be in communication through a local access network or other networks currently known and used in the art.

The management system 10 is organized by the CPU 22 in a plurality of web pages. Preferably, the web pages are all organized under one home page 58, as shown in FIG. 7a. The home page 58 may include a default display showing the day's scheduled events. In addition, a link to upcoming events and a system log 60 may also be included. The system log 60 provides a list of all the changes made to the system within a predetermined period. The home page 58 includes links for the calendar 26, address book 28, biography database 48, reporting database 30, and list of facilities 54. The interface 20 is operable to select any one of the links so as to display the corresponding link.

For instance upon selection of a calendar link the CPU 22 will display the calendar 26. The calendar 26 includes all of the dates and events that have been entered into by the user. Each of the events and dates appearing in the calendar 26 is linked and in communication with the document associating circuit 32. Upon selection of an event by the interface 20, the document associating circuit 32 processes the first and second databases 14, 24 and delivers information relating to the selected event. For example, all of the documents contained in the first and second databases 14, 24 relating to the selected event may be displayed on the web page.

With reference again to FIGS. 2 and 2a, a calendar 26 having a plurality of dates and events is provided. Specifically on Apr. 21, 2009 an “Energy Hearing” is scheduled. Upon selection of the “Energy Hearing” all of the documents stored in the first and second databases 14, 24 relating to the “Energy Hearing” are delivered to include meeting minutes, agendas, names of the participants (principals, staffers, and members) and the like. Thus the management system 10 delivers information to the user so as to help the user prepare for the upcoming meeting.

The document associating circuit 32 is operable to find all the documents relating to the meeting using known data mining technology and filtering technologies. For instance, each document relating to the Energy Hearing may include metadata which contains “Energy Hearing.” Thus the document associating circuit 32 is operable to process the first and second databases 14, 24 for all documents and files having metadata containing the term “Energy Hearing.”

With reference to the address book 28, the address book 28 contains a list of contacts 44 containing information relating to a particular contact. The document associating circuit 32 is operable to deliver all of the documents relating to a selected contact. For example the selection of “John Smith” prompts the document associating circuit 32 to process the first and second databases 14, 24 for all documents containing the words “John Smith.” Thus the user is able to peruse through each of the documents to determine which documents may be relevant in generating a meeting or a memo with “John Smith.”

The document associating circuit 32 may be filtered so as to limit the number of documents delivered upon selection of any particular calendar event or contact. In one example of a filter, the document associating circuit 32 is configured to search and retrieve documents from a particular location. Accordingly, the document associating circuit 32 reduces the amount of documents delivered. For instance, the document associating circuit 32 may be configured to search only documents contained in the reporting database 30 when a calendar event is selected by the interface 20.

With reference again to FIGS. 3 and 3e, an illustration of the filtered document associating circuit 32 is provided. The address book 28 displays a list of contacts, including “Representative One.” Upon selection of “Representative One,” the document associating circuit 46, 32 processes the reporting database 30 to locate any documents containing the terms “Representative One.” Naturally for a broader result, the document associating circuit 32 may search both the first and second databases 14, 24 for any document containing the term “Representative One.”

It is anticipated that the document associating circuit 32 may have other conditions for filtering a search. For instance, the document associating circuit 32 may filter a search by excluding documents that are dated prior to a predetermined date, or documents that are not word documents, such as spreadsheets, figures, or the like.

The system may also include an alert 52. The interface 20 is operable to generate an alert 52 for any time sensitive calendar event. In one embodiment, each event includes an icon for the alert 52 (not shown). Upon actuation of the icon the settings for an alert 52 may be established. Thus the system is able to customize the period for which notice of an upcoming event is provided.

With reference again to FIGS. 6 and 6a, a list of facilities 54 is provided on one of the web pages. The web page displays a list of all the facilities stored within the second database 24. The server 12 is operable to update the list of facilities 54 with information provided by the feed 18. Thus when the phone number of a facility is changed the server 12 is able to gather the updated information from the live feed 18 and update the second database 24. The zip code associating circuit 56 is operable to identify personnel provided by the feed 18 that are associated with the zip code of any one of the facilities stored in the list of facilities 54. Upon selection of a facility, the zip code associating circuit 56 is operable to produce a list of all personnel having a zip code that is similar to or within a predetermined geographical area of the selected facility.

Accordingly the web based management system 10 facilitates the management of data and events by providing updated information relating to facilities, personnel and the like. Furthermore the management system 10 facilitates the preparation of a report or meeting by providing the documents relating to the report or meeting to the user upon selection of a particular item, event or report.

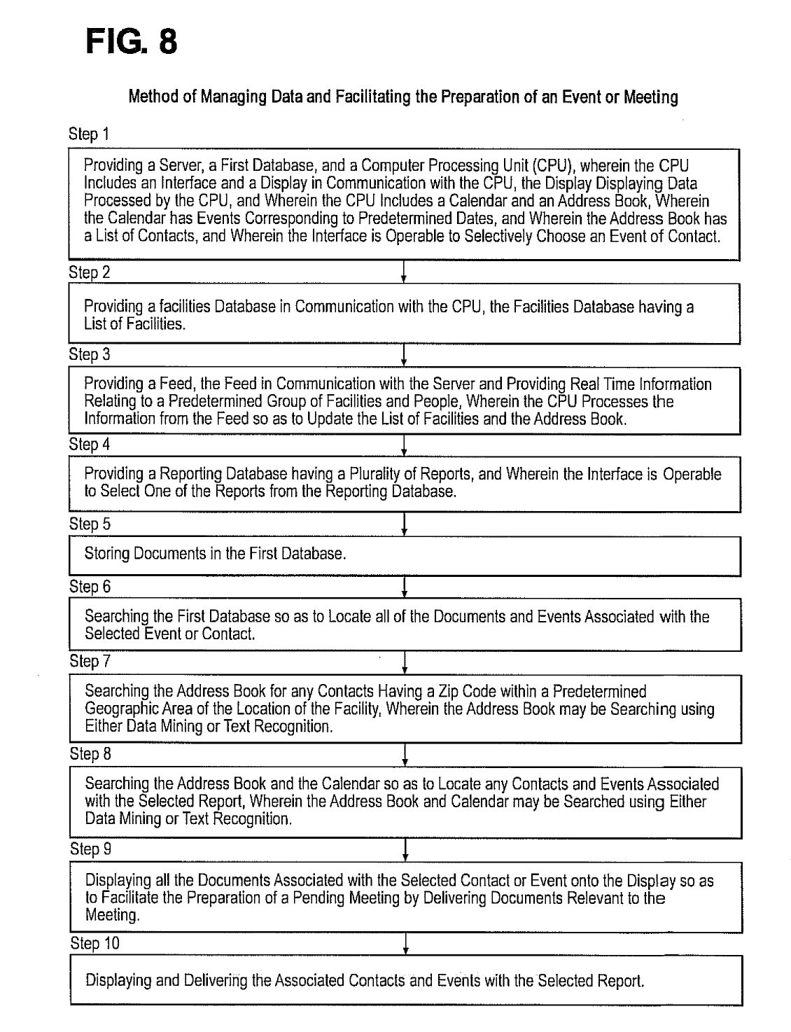

With reference now to FIG. 8, a method of managing data stored in electronic form is provided. The method includes the steps of providing a server 12, a first database 14, and a CPU 22. The CPU 22 includes an interface 20. A display is in communication with the CPU 22 and displays data. The CPU 22 includes a calendar 26 and an address book 28. The calendar 26 includes events corresponding to predetermined dates. The address book 28 has a list of contacts 44. The method further includes the step of storing documents in the first database 14.

The interface 20 is operable to navigate through the calendar 26 and address book 28 so as to selectively choose an event or a contact. Upon selection of either a contact or event, the method proceeds to search the first database 14 so as to display any documents associated with the selected contact or event onto the display. Accordingly, the method facilitates the preparation of a pending meeting by delivering documents relevant to the meeting.

The method may further include the step of providing a second database 24, a reporting database 30 in communication with the CPU 22, and a feed 18 in communication with the server 12. The interface 20 is operable to create documents and the CPU 22 is operable to process the created documents and store them in the second database 24. The method may further include the step of searching the first and second database 14, 24 so as to display any documents associated with the selected contact or event onto the display.

The method may further include the step of providing a list of facilities 54. The interface 20 may be operable to manually create a list of facilities 54. Alternatively, the list of facilities 54 may be provided by the feed 18. The list of facilities 54 may be stored in the second dataset. The CPU 22 may update the list of facilities 54 from information provided by the feed 18 so as to keep the list of facilities 54 current. The interface 20 is further operable to selectively choose a facility from the list of facilities 54. Upon selection of a facility, the method proceeds to searching the address book 28 for any contacts having a zip code within a predetermined geographic area of the location of the facility.

The method may also include the step of providing a reporting database 30. The reporting database 30 may contain reports generated by a user or manufactured reports uploaded into the CPU 22. The server 12 is operable to store the reports in the reporting database 30 and the server 12 is further operable to update information on the report using information provided by the feed 18.

The interface 20 is operable to select a report from the reporting database 30. Upon selection of a report, the method proceeds to searching the address book 28 and the calendar 26 so as to locate any contacts and events associated with the selected report. The method them proceeds to delivering the associated contacts and events with the selected report.

Obviously, many modifications and variations of the present invention are possible in light of the above teachings and may be practiced otherwise than as specifically described while within the scope of the appended claims. In addition, the reference numerals in the claims are merely for convenience and are not to be read in any way as limiting.

We claim:

1. A management system for managing data stored in electronic form and facilitating the preparation of an event or meeting, the management system comprising:
a server having a first database and a processor,
a computer processing unit having an interface and a second database, the computer processing unit in communication with the server;
a display in communication with the computer processing unit, the display operable to display information processed by the computer processing unit;
a calendar and a document associating circuit, wherein the interface is operable to input events onto the calendar and to associate an event with a predetermined time, and wherein the document associating circuit is operable to process the first and second database so as to associate documents stored in the first and second database with each event displayed on the calendar, and
a feed in communication with the server, the feed providing real time information relating to a predetermined group of people and facilities, wherein the processor is operable to process the real time information so as to update the first database with information from the feed at a predetermined interval, and wherein the interface is operable to select any of the events so as to deliver the associated document with the selected event.

2. The management system as set forth in claim 1, further including an address book having a list of contacts and information relating to each of the contacts, wherein the address book is stored in the second database, and wherein the server is operable to upload the feed into the address book so as to update the address of each of the contacts, and wherein the interface is operable to add contacts and the information of each contact to the list of contacts, and wherein the document associating circuit is further operable to search the first and second database, and the calendar so as to provide any documents and events associated with the selected contact onto the display.

3. The management system as set forth in claim 1, further including a filtering circuit in communication with the calendar, the filtering circuit including a labeling system having a predetermined number of labels, and wherein the interface is operable to associate each of the events with one of the labels, and wherein the filtering circuit is operable to display only the events labeled with a selected label.

4. The management system as set forth in claim 1, further including a status circuit having a code system including a predetermined number of codes, wherein the interface is operable to associate each of the events with one of the codes.

5. The management system as set forth in claim 1, further including a biography database containing a list of biographies, wherein each biography in the list includes the information of personnel, and wherein the server is operable to update the list of biographies with information provided by the feed, and wherein the interface is operable to add biographies to the list of biographies.

6. The management system as set forth in claim 1, a reporting database in communication with the computer processing unit, the reporting database having at least one report, wherein the interface is operable to generate a report and wherein the computer processing unit is operable to store the generated report in the reporting database, and wherein the computer processing unit is operable to update information on the report using the information provided by the feed.

7. The management system as set forth in claim 3, wherein interface is operable to select one of the reports in the reporting database wherein the document associating circuit is operable to process and search the reporting database, and the first and second databases so as to deliver all documents associated with the selected report stored in the first and second databases onto the display, and wherein the document associating circuit is further operable to process and search the address book, the calendar so as to deliver all contacts and events associated with the selected reported onto the display.

8. The management system as set forth in claim 1, a facilities database, wherein the server is operable to load the facilities database with facilities and information relating to the facilities using information provided by the feed, and wherein the interface is operable to enter facilities and information relating to the facilities into the facilities database and to selectively choose one of the facilities in the facilities database; and
a zip code associating circuit, the zip code associating circuit operable to identify personnel provided by the feed that are associated with the zip code of any one of the facilities stored in the facilities database and produce a list of all personnel having a zip code that is the same as the zip code of the selected facility.

9. The management system as set forth in claim 1, further including an alert, wherein the computer processing unit is operable to process the calendar and the reporting database so as to determine when an event or report is due so as to generate an alert for the event or report.

10. The management system as set forth in claim 1 wherein the document associating circuit is in communication with the address book, and wherein the document associating circuit is operable to process and search the address book and the first and second database so as to associate all of the documents stored in the first and second database to each of the contacts stored within the address book, and wherein the interface is operable to select anyone of the contacts in the address book and produce all of the documents stored in the first and second database relating to the selected contact.

11. The management system as set forth in claim 1, wherein the server is remotely located from the computer processing unit.

12. A method of managing data stored in electronic form and facilitating the preparation of an event or meeting, the method comprising the steps of:
providing a server, a first database, and a computer processing unit, wherein the computer processing unit includes an interface and a display in communication with the computer processing unit, the display displaying data processed by the computer processing unit, and wherein the computer processing unit includes a calendar and an address book, the calendar having events corresponding to predetermined dates, and wherein the address book has a list of contacts, and wherein the interface is operable to selectively choose an event or contact;
providing a feed having updated information of contacts, the computer processing unit in communication with the feed and operable to update the address book with updated information;
storing documents in the first database;
searching the first database so as to locate all of the documents and events associated with the selected event or contact; and
displaying all the documents associated with the selected contact or event onto the display so as to facilitate the preparation of a pending meeting by delivering documents relevant to the meeting.

13. The method as set forth in claim 12, further including the step of providing a facilities database in communication with the computer processing unit and the feed, wherein the computer processing unit processes the information from the feed so as to create a list of facilities and imports the list of facilities into the facilities database; and
searching the address book for any contacts having a zip code within a predetermined geographic area of the location of the facility.

14. The method as set forth in claim 13, further including the step of providing a reporting database having a plurality of reports, and wherein the interface is operable to select one of the reports from the reporting database;
searching the address book and the calendar so as to locate any contacts and events associated with the selected report; and
delivering the associated contacts and events with the selected report.

15. The method as set forth in claim 14, wherein the first database is searched using data mining technology.

16. The method as set forth in claim 14, wherein the first database is searched using text recognition and seaming.
